(19) United States
(12) Patent Application Publication
(10) Pub. No.: US 2020/0196135 A1
(43) Pub. Date: Jun. 18, 2020

(54) ENHANCED CONNECTIVITY IN DUAL-MODE NETWORKS FOR SINGLE-MODE NODES

(71) Applicant: Avaya Inc., Santa Clara, CA (US)

(72) Inventor: Dusan Mudric, Ottawa (CA)

(21) Appl. No.: 16/224,464

(22) Filed: Dec. 18, 2018

(51) Int. Cl. H04W 8/26; H04L 29/12; H04L 29/06

(52) U.S. Cl. CPC H04W 8/26; H04L 61/1511; H04L 69/163; H04L 69/167; H04L 61/2007

(57) ABSTRACT

Systems, methods, software and apparatus to enhance connectivity to nodes in a single-mode network environment. An ordered list of IP address is generated based on configuration order rules, and each IP address is probed to determine reachability.

### FIELD OF THE DISCLOSURE

The present disclosure is generally directed toward communications and more particularly toward enhancing connectivity for devices that may transition between dual-mode and single-mode for communications in a communication network that may transition from single-mode and dual-mode.

### BACKGROUND

Communication devices are used for voice and video calling, video conferencing, gaming, Internet access, media streaming, data messaging, email, machine-to-machine data transfers, computerized information services, and the like. These services may be provided by applications running on the communication devices. The applications interact with application servers to provide their services. The communication devices may be phones, smartphones, computers, laptops, tablets, wearable devices, media players, intelligent machines, and the like. Devices may also communicate with other communication devices. In order to communicate with application servers and/or other devices, the applications and/or client devices transmit data over a network. A communication network uses various communication protocols to transmit data. The Internet uses protocols such as Internet Protocol version 4 (IPv4) and Internet Protocol version 6 (IPv6). A dual-stacked network is a network that allows devices to use both IPv4 and IPv6 to transmit data.

Communication networks use hostnames and/or domain names, which are resolved to one or more IP addresses to route traffic. For example, if a user wants to access the streaming video service NETFLIX®, the user may enter the domain name “netflix.com” into the address bar of the web browser application. The hostname “netflix.com” is stored along with IP address(es) of the host in a Domain Name Server (DNS). In other words, the DNS translates a domain name into an IP address. A domain name may resolve to multiple IP addresses. Each IP address may have different performance and/or connectivity characteristics. An IP address is a numerical label assigned to a device connected to an IP network. IPv4 define addresses using a 32-bit number (e.g., 192.16.254.1). IPv6 defines addresses using 128-bits (e.g., 2001:db8:0:1234:0:567:8:2). Domain names may resolve to IPv4 address(es), IPv6 address(es), or both. That is to say, the same domain name may be used for IPv4 and IPv6. A client performs DNS queries to obtain an IP address for an application server (e.g., “A” query in IPv4 and “AAAA” query in IPv6). In other words, in a dual-mode network, a domain name may resolve to IPv4 and IPv6 addresses. In some situations, specific addresses and/or address families (i.e., IPv4 or IPv6 addresses) may be blocked, broken, otherwise unreachable, or sub-optimal (e.g., slower speeds, congested, etc.). In order to more quickly establish a connection with a server, clients may attempt multiple connections in parallel. For example, a client may send a request to an IPv4 address for a server in parallel with a request sent to an IPv6 address for the same server.

### SUMMARY

Embodiments of the present disclosure seek to enhance connectivity for devices operating in a single-mode network. In some embodiments, a dual-mode network may be reconfigured to be a single-mode network. For example, in dual-mode (i.e., IPv4 and IPv6 enabled), applications and/or devices may use any combination of IPv4, and IPv6 addresses to reach either single-mode or dual-mode remote hosts and servers. However, if the network becomes single-mode (i.e., IPv6 only) some applications and/or devices may not be able to reach remote hosts/servers. For example, the application may be trying to connect to the remote host using an IPv4 address. In another example, the requested service may only be available from a server that is IPv4 only. In some embodiments, it may be that the network is dual-mode, but the remote host/server may be configured to be single-mode (i.e., IPv6 only) and may only be accessible via FQDNs and IPv6 addresses. Therefore, if a client tries to connect to a single-mode host/server using an IPv4 address, it may cause connection delay (i.e., a server may be unreachable), which results in a poor user experience. Therefore, before attempting to connect to a remote host/server, the application/client should define an order based on IP mode to attempt the multiple IP addresses. In some embodiments, the list comprises server IP addresses of FQDN resolved addresses and may be ordered based on network IP mode. If the network IP mode changes from dual-mode to IPv6 only, IPv6 addresses should be selected, if available, while IPv4 addresses should be ignored. If the server is only reachable via IPv4 addresses, then the client may attempt to locate the server on the local link using IPv4 mapped IPv6 addresses. Additionally, the client may even perform probes, in order to enhance connectivity. Advantageously, this will shorten connection time and improve the user experience.

It is, therefore, one aspect of the present disclosure to provide a method of defining application behavior when the subnet is changed from dual-mode to single-mode. In some embodiments, IP addresses may be ordered based on IP mode, while IPv4 addresses are ignored. Additionally, addresses may be probed before they are used, with unreachable addresses being skipped. Furthermore, an IPv6 socket may be used to access IPv4 service on a local link by converting IPv4 address into IPv4-mapped IPv6 addresses.

In this model an application and/or device may manage server addresses for communications. In some embodiments, the application and/or device may determine a network IP mode. For example, if the application is running on a host that is IPv6 only, the application may determine that the network IP mode is IPv6 only. Since the network IP mode is IPv6 only, the application or client sends a DNS query over IPv6 only and does not send a DNS query over IPv4. A device may select DNS addresses based on network IP Mode and attempt connections using the selected address (IPv6 addresses for IPv6 only network). The DNS may return IP addresses associated with the hostname and/or domain name. In some embodiments, the DNS may return IPv6 addresses only. In other embodiments, the DNS returns both IPv4 and IPv6 addresses, which the client must filter and/or order based on IP mode.

The application or client may then attempt to connect to the remote host/server using the IP addresses returned from the DNS. In some embodiments, the client may also query other sources for IP addresses, such as a Dynamic Host Configuration Protocol (DHCP) server, a setting file, static/manual entry, and/or other sources—including combinations thereof. The application or client may determine an order to attempt the returned IP addresses. The IP addresses may be ordered based on IP mode, source, type, etc.

In some embodiments, addresses will be ordered based on network IP mode. For example, IPv6 addresses will be attempted before IPv4 addresses. In other embodiments, an address family may be ignored. For example, IPv4 addresses may be skipped. Additionally, some addresses may be preferred over others based on configuration rules. Configuration rules may include IP version preference, address families to be ignored, and/or other ordering algorithms—including combinations thereof. In some examples, services to certain addresses may be stopped or paused to minimize battery consumption (e.g., IoT or low energy devices).

In some embodiments, a host or application server connected to a dual-stacked network (i.e., an IPv4 and IPv6 network) may be configured to a single-mode (i.e., IPv4 or IPv6 only). The DNS may include IPv4 addresses, which may be returned from a DNS query. However, since the host is IPv6 only, the IPv4 addresses will be unreachable, and, therefore, should be ignored in order to avoid unnecessary connection delay and/or lack of functionality if the server is unreachable.

In some embodiments, a network and/or host configured in single-mode may be reconfigured to dual-mode, and therefore, IPv4 addresses that were previously skipped/ignored should not be skipped/ignored in dual-mode. Therefore, it would be advantageous for the application/client to make a determination of the IP mode of the network and/or remote host/server.

In some embodiments, an administrative user may configure the network to be single-mode (e.g., IPv6 only). In some examples, the administrator may set a flag in the router(s) to indicate that the network is single-mode. In some embodiments, the flag is a protected flag and is set using a setting file transferred using a secure protocol (i.e., HTTPS). In other embodiments, the router may be configured to single-mode using a configuration or setting file. The router(s) configured to single-mode may then transfer a message to all connected to host(s), that the network is single-mode (e.g., IPv6 only). In some embodiments, the host(s) may determine the network is single-mode by querying the router, receiving a configuration file, previous failed attempts to IPv4 addresses, etc. Applications running on the hosts will determine that the host is IPv6 only, and order IP addresses accordingly.

In other embodiments, some remote hosts may be accessible using one address family (e.g., IPv4 addresses only). For these hosts the client may perform Network Address Translation (NAT64). The IPv4 addresses may be converted into IPv6 addresses and accessed via an IPv6 socket. In some embodiments, IPv4-mapped IPv6 addresses are used as the last resort when an IPv6 only host is reachable only using IPv4 server addresses. The host will try to find the IPv4 only server on its local link using IPv4-mapped IPv6 address.

In other words, it is an aspect of the present disclosure to enhance connectivity in single-mode networks. In some embodiments, the connected communication nodes are dual-mode. In other embodiments, the connected communication nodes are single-mode. Furthermore, the methods discussed herein may be applied to single-mode devices operating on dual-mode networks. By defining an order to attempt IP addresses in order to attempt reachable addresses first, this advantageously reduces the time it takes to make a successful connection, thereby improving the user's experience.

In some embodiments, a method is provided that generally comprises:

determining a network IP mode for a host hosting an application making a service request;

transferring a request for one or more IP addresses associated with the service request;

determining an order for each IP address based on configuration order rules;

probing at least some of the one or more IP addresses in the ordered list of IP addresses to determine reachability; and

generating a list of reachable IP addresses.

In another embodiment, another method is provided that generally comprises:

determining an application making a service request is hosted on a single-mode device, wherein the single-mode device is connected to a dual-mode network;

transferring a request for one or more IP addresses associated with the service request;

determining an order for each IP address based on configuration order rules;

probing at least some of the one or more IP addresses in the ordered list of IP addresses to determine reachability; and

generating a list of reachable IP addresses.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of” A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 1.12(f) and/or Section 1.12, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram illustrating a single-mode and a dual-mode host in accordance with embodiments of the present disclosure;

FIG. 2 illustrates an example of Network Address Translation (NAT) in accordance with embodiments of the present disclosure;

FIG. 3a is a block diagram depicting enhanced connectivity in accordance with embodiments of the present disclosure;

FIG. 3b is a block diagram depicting enhanced connectivity for single-mode network in accordance with embodiments of the present disclosure;

FIG. 4 illustrates an example Domain Name Server query to resolve a Fully Qualified Domain Name to establish a connection between a client and in accordance with embodiments of the present disclosure;

FIG. 5 illustrates an example of a single-mode router in accordance with the present disclosure;

FIG. 6 is a flow diagram depicting the process implemented by a client and/or application to enhance connectivity to nodes in a single-mode network in accordance with embodiments of the present disclosure;

FIG. 7 illustrates an example of a DNS query in accordance with embodiments of the present disclosure;

FIG. 8a illustrates an example a DNS query message flow to establish a connection between a client and a server in accordance with embodiments of the present disclosure;

FIG. 8b illustrates an example an IP address query message flow in accordance with embodiments of the present disclosure and

FIG. 9 is a block diagram of a computer used to implement the method to enhance media path setup in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

It should be appreciated that embodiments of the present disclosure can be utilized in numerous address selection scenarios.

Furthermore, while the illustrative embodiments herein show the various components of a system collocated, it is to be appreciated that the various components of the system can be located at distant portions of a distributed network, such as a communication network and/or the Internet, or within a dedicated secure, unsecured, and/or encrypted system. Thus, it should be appreciated that the components of the system can be combined into one or more devices, such as an enterprise server or collocated on a particular node of a distributed network, such as an analog and/or digital communication network. As will be appreciated from the following description, and for reasons of computational efficiency, the components of the system can be arranged at any location within a distributed network without affecting the operation of the system. For example, the various components can be located in a local server, at one or more users' premises, or some combination thereof.

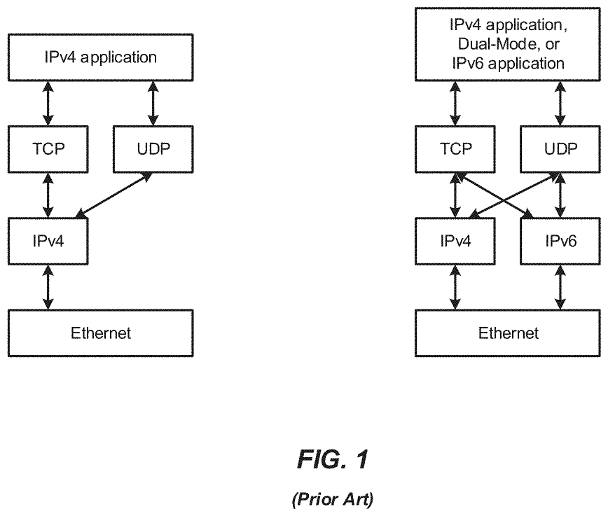

With reference initially to FIG. 1, the Internet is a dual-stacked network in which IPv4 and IPv6 operate in tandem. In other words, nodes may be reachable using IPv4 addresses, IPv6 addresses, or both. IPv4 addresses have a different format than IPv6 addresses, and the two formats are not compatible. Methods such as NAT and tunneling allow devices to communicate using different IP address formats. Tunneling allows packets to be transmitted from one protocol to the other by encapsulating the packets of one protocol in packets of the other protocol. In other words, IPv6 packets are encapsulated in IPv4 packets and vice versa.

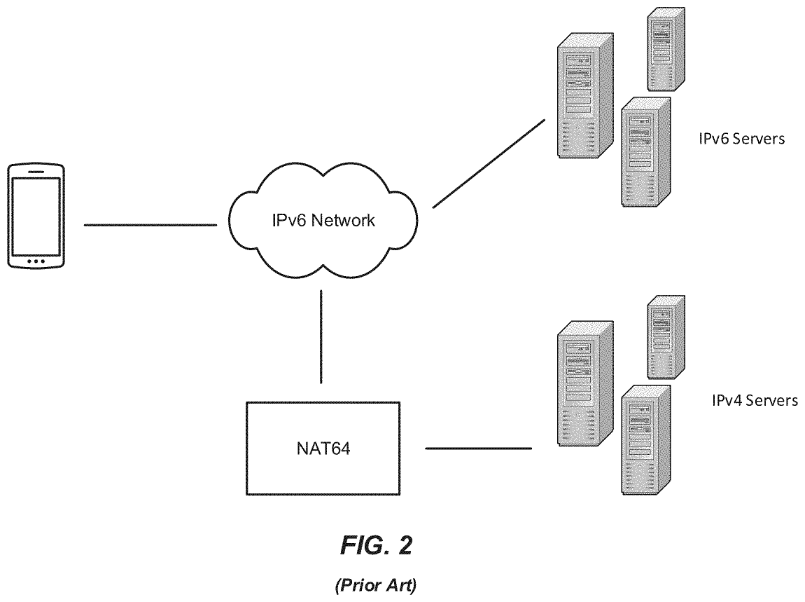

Network Address Translation (NAT), illustrated in FIG. 2, facilitates communication between IPv4-only and IPv6-only hosts and/or networks, by performing IP header and address translation between the two address families.

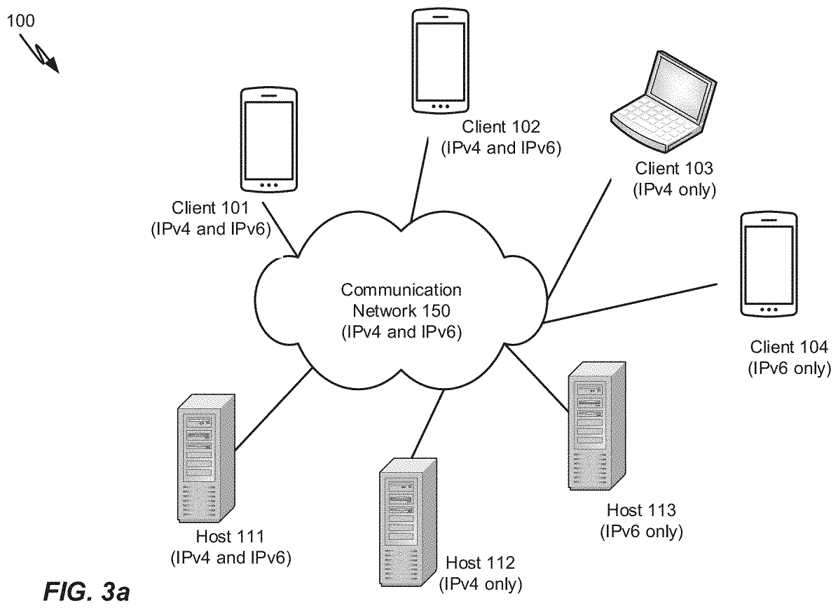

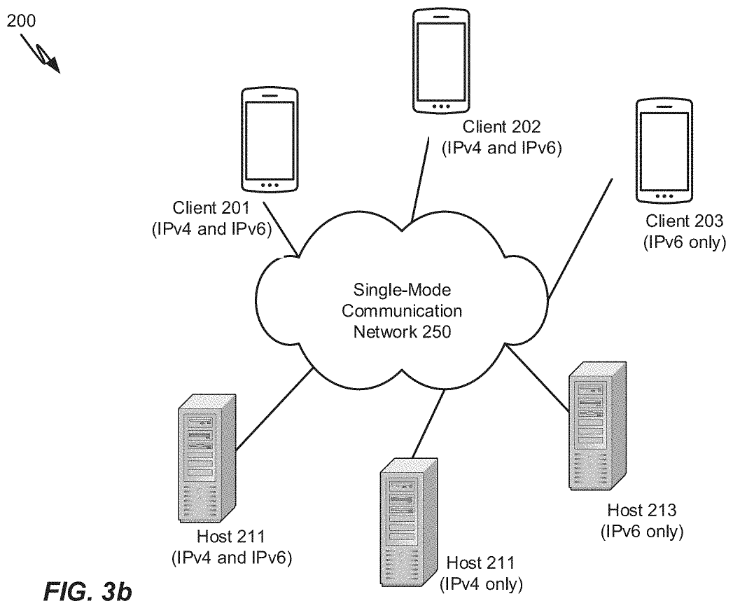

With reference to FIG. 3a, an illustrative communication system 100 in which single-mode connectivity is enhanced as will be described in accordance with at least some embodiments of the present disclosure. The system 100 is shown to include clients 101-104, Hosts 111-113, and communication network 150. Client 101-102 and Host 111 are IPv4 and IPv6 enabled. Client 103 and Host 112 are IPv4 only, and Client 104 and Host 113 are IPv6 only. In other words, Clients 103-104 and Hosts 112-113 are single-mode devices connected to a dual-mode network. While in single-mode, Client 103 and Host 112 are accessible using IPv4 only, similarly, Client 104 and Host 113 are accessible using IPv6 only.

In accordance with at least some embodiments of the present disclosure, the communication network 150 may comprise a dual-stacked network and may comprise any type of known communication medium or collection of communication media and may use any type of protocols (e.g., IPv4 and IPv6) to transport messages between communication nodes.

The communication network 150 may include wired and/or wireless communication technologies. The Internet is an example of a communication network 150 that constitutes an Internet Protocol (IP) network consisting of many computers, computing networks, and other communication devices located all over the world. Other examples of communication networks include, without limitation, a standard Plain Old Telephone System (POTS), an Integrated Services Digital Network (ISDN), the Public Switched Telephone Network (PSTN), a LAN, a WAN, a Session Initiation Protocol (SIP) network, a Voice over IP (VoIP) network, a cellular network, an enterprise network, and any other type of packet-switched or circuit-switched network known in the art. In addition, it can be appreciated that communication network 150 need not be limited to any one network type, and instead may be comprised of a number of different networks and/or network types. Moreover, communication network 150 may comprise a number of different communication media such as coaxial cable, copper cable/wire, fiber-optic cable, antennas for transmitting/receiving wireless messages, and combinations thereof. Although, only one network is shown for clarity, in some embodiments, there may be more than one network using the same or different communication protocols.

In some embodiments, Clients 101-104 may include a personal communication device. Examples of suitable Clients 101-104 include, without limitation, a telephone, a softphone, a cellular phone, a multi-speaker communication device (e.g., conference phone), a video phone, a PC, a laptop, a tablet, a PDA, a smartphone, a thin client, or the like. In various embodiments, Hosts 111-113 may include server computers, cloud computing platforms, data centers, and any physical or virtual computing machine, as well as any variation or combination thereof.

With reference to FIG. 3b, an illustrative communication system 200 in which connectivity over a single-mode network is enhanced as will be described in accordance with at least some embodiments of the present disclosure. The system 200 is shown to include clients 201-203, Hosts 211-213, and communication network 250. Client 201-202 and Host 211 are IPv4 and IPv6 enabled. Host 212 is IPv4 only, and Client 203 and Host 213 are IPv6 only. In other words, Client 203 and Hosts 212-213 are single-mode devices connected to a single-mode network. While in single-mode, Host 212 are accessible using IPv4 only, similarly, Client 203 and Host 213 are accessible using IPv6 only.

In accordance with at least some embodiments of the present disclosure, the communication network 250 may comprise a single-mode network and may comprise any type of known communication medium or collection of communication media and may use any type of protocols (e.g., IPv4 or IPv6) to transport messages between communication nodes.

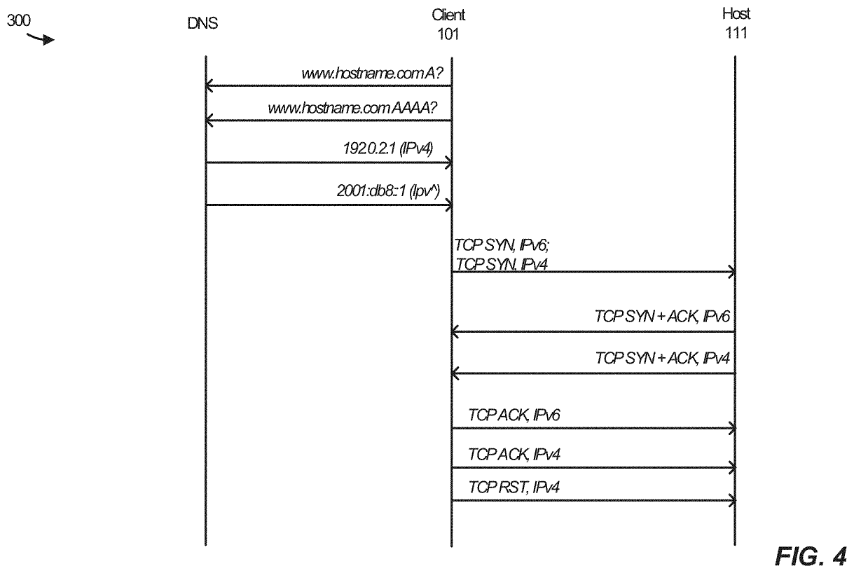

FIG. 4 illustrates an example message flow for the DNS query when client 101 attempts to connect to Host 111. Client 101 requests the IPv4 and IPv6 records for Host 111 from the DNS. For example, Client 101 may transfer an “A” DNS query and an “AAAA” DNS query with the domain name associated with Host 111. The DNS returns the IPv4 and IPv6 address(es) for Host 111. Client 101 determines which protocol provides a better connection by attempting multiple connections in parallel. Client 101 checks both IPv4 and IPv6 connectivity and uses the first connection returned.

For example, when Client 101 attempts to start a TCP connection to Host 111, Client 101 and Host 111 exchange a series of messages, which may proceed as follows: Client 101 requests a connection by sending a TCP SYN (synchronize) message to Host 111, Host 111 acknowledges the request with a TCP SYN ACK back to Client 101, Client 101 responds with an ACK, and the connection is established.

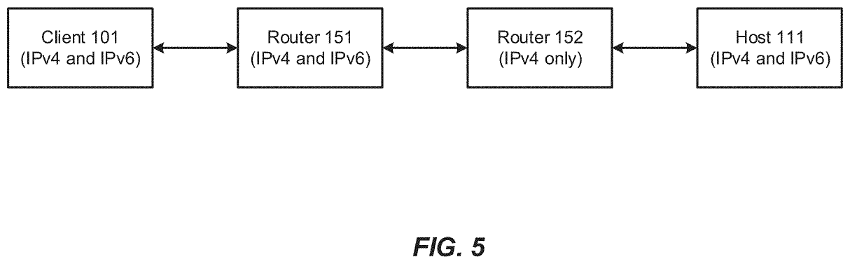

In addition to clients and servers, other nodes within a communication network may be configured for single-mode. FIG. 5 illustrates an example, where a router 152 between Client 101 and Host 111 is IPv4 only.

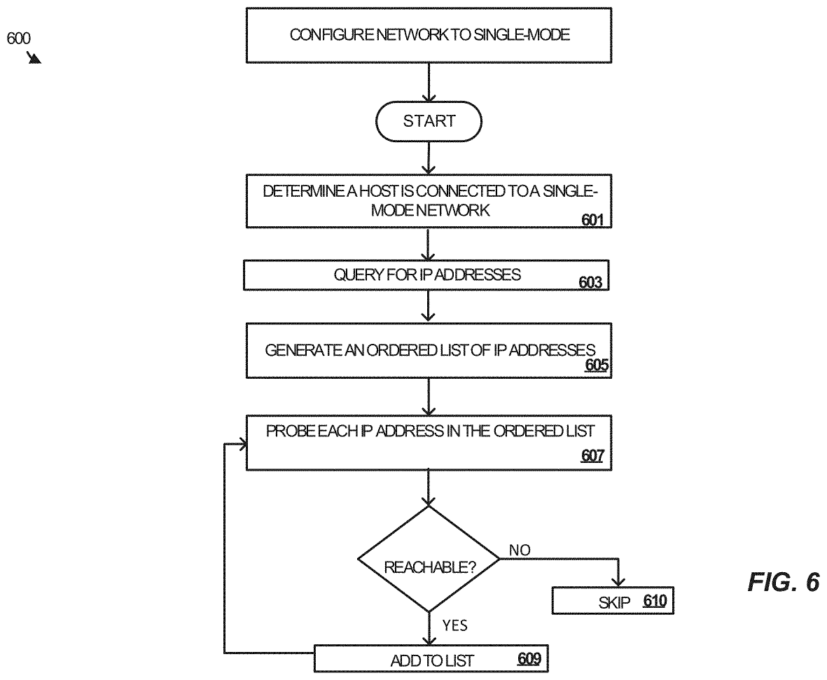

With reference now to FIG. 6, additional details of a process 600 for enhancing connectivity to nodes on a single-mode network will be described in accordance with at least some embodiments of the present disclosure. The processes of operation 600 are referenced parenthetically in the paragraphs that follow.

As illustrated in FIG. 6, operation 600, an application determines the host is connected to a single-mode network (step 601). For example, the host may receive a message from a router indicating the network is IPv6 only. In some embodiments, the host may also be single-mode. In other embodiments, the host may be single-mode while the network is dual-mode. The host and/or application queries for IP addresses (step 603). For example, the user enters “www.awebsite.com” into the address bar of a browser application. The browser application queries one or more source for the IP address of a server associated with that website. For instance, the application may query a DNS and/or DHCP server for IP addresses associated with website's server. In some embodiments, the application and/or server determines that the host and/or network is single-mode. If the determination is made prior to the queries, then the application and/or host may transfer the queries in the specified mode. In other words, if the application determines that the host and/or network is IPv6 only, the application will transfer the DNS queries over IPv6 only.

After receiving responses to the queries for IP addresses, the application may order the IP addresses based on configuration order rules (step 605). In some cases, the queries may return both IPv4 and IPv6 addresses, since the host and/or network is IPv6 only, IPv4 addresses should be ignored. Additionally, IP addresses may be ordered based on other factors, such as FQDNs being preferred over static or manually entered IP addresses.

In some embodiments, the application may probe each address in the ordered list (step 607). The IP addresses may be re-ordered based on reachability. For example, reachable addresses may be added to a list of resolved addresses (step 609), and unreachable addresses are skipped (step 610). In some embodiments, the network may be reconfigured to dual-mode, and the previously ignored IPv4 addresses may be re-considered. However, IPv6 addresses may still be preferred.

A similar process may be used when the application determines that the host is single-mode, whether or not the network is single or dual-mode. For example, a client determines that a server is reachable using IPv6-only. The client generates an ordered list of IP addresses for the server. For example, the client may perform a DNS query to obtain the IP addresses for the server. In some embodiments, a user enters a hostname in the address bar of a browser application running on the client. The hostname is resolved to the associated IP addresses. The returned IP addresses are ordered based on configuration order rules. In this example, the client may need to order the received IP addresses based on network IP mode and select only IPv6 addresses. The configuration order rules may specify that FQDNs should have the highest preference. In another example, IPv6 addresses may be preferred over IPv4 addresses. In yet another example, the configuration order rules may indicate that IPv4 addresses should be ignored completely.

Each address in the ordered list is probed (step 607). For example, connection requests are sent to each IP address. In some embodiments, the probes may be done in parallel. In other embodiments, the probes are done in series. Reachable addresses are added to the list of resolved IP addresses, while unreachable addresses are skipped.

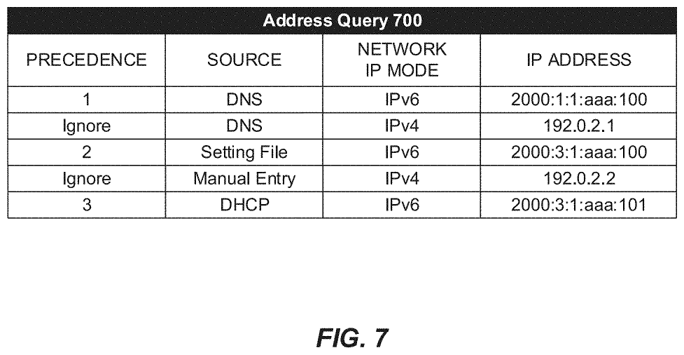

FIG. 7 illustrates an example of an ordered list of IP addresses in accordance with the embodiments described herein, although other data formats are possible and in accordance with the embodiments described herein.

Address query 700 comprises the fields/columns “PRECEDENCE,” “SOURCE,” “NETWORK IP MODE,” “IP ADDRESS.” The columns listed in Address Query 700 are for illustrative purposes only, and not all columns are required, additionally, the table may include other columns not listed in this example. The “PRECEDENCE” field may list the order to attempt connection using the IP address or whether the IP address should be skipped/ignored. The “SOURCE” field may list the source of the IP address. For example, the application may send multiple queries to multiple sources requesting an IP address. The results of the queries are combined into a list. The “NETWORK IP MODE” field may indicate the address family/format for the IP address (i.e., IP version). The “IP ADDRESS” field may list the IP address.

For example, a client may generate address query 700 in response to performing a DNS and DHCP server query on an entered hostname. For example, an application running on the client may request access to the application server.

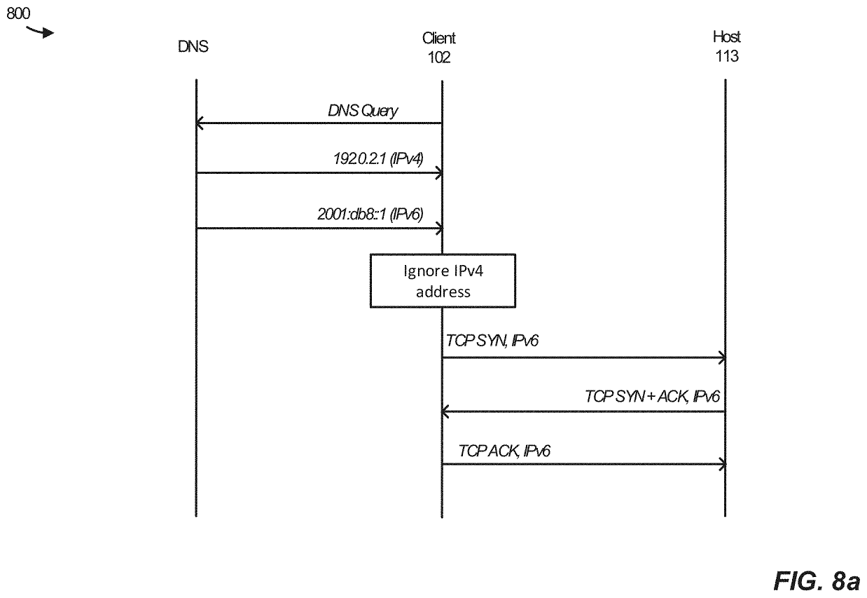

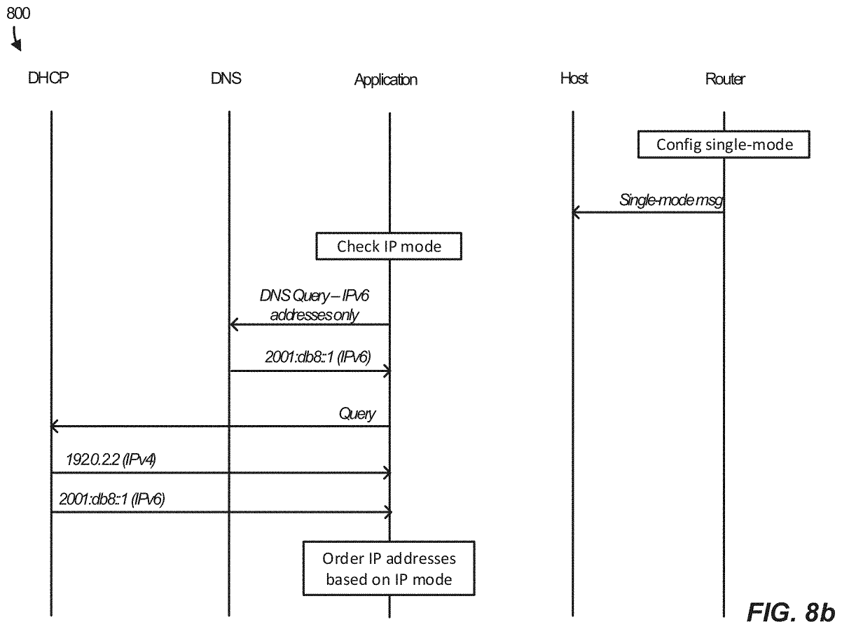

FIG. 8a illustrates an example message/signaling flow for establishing a connection between dual-mode Client 102 and single-mode Host 113. Client 102 queries the DNS for IP addresses for Host 113. The DNS returns the IPv4 and IPv6 address(es) for Host 113. Client 102 determines that the network is single-mode/IPv6 only, therefore, IPv4 addresses are ignored, and Client 102 attempts to start a TCP connection to Host 113 using IPv6. Client 102 requests a connection by sending a TCP SYN (synchronize) message to Host 113, Host 113 acknowledges the request with a TCP SYN ACK back to Client 102, Client 102 responds with an ACK, and the connection is established.

FIG. 8b illustrates an example message/signaling flow for making multiple IP address queries. A router may notify or otherwise indicate to a host that the network is configured in single-mode. In some examples, the router may be configured to single-mode by an administrative user. Once configured to single-mode, the router may send messages to all connected nodes indicating that the network is single-mode. An application running on the host may make a service request, before making the request, the application may determine an IP mode for the host and/or the network. In this example, the application determines that the network IP mode is single-mode or IPv6 only. In response to making this determination, the application may transfer queries using IPv6 only. Additionally, the queries may indicate that only IPv6 addresses should be returned. In other examples, the application filters out an IPv4 addresses returned. The application may further order the IPv6 addresses based on additional factors, such as source, number of hops, etc.

With reference it to FIGS. 8a-b, the IP mode may determine what IP mode IP address queries are sent and/or IP addresses used to connect to servers.

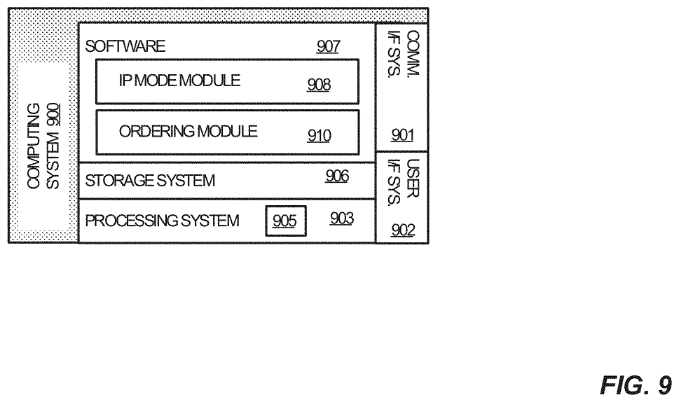

FIG. 9 illustrates computing system 900 used to enhance connectivity to a single-mode node in a dual-mode network as described herein, according to one implementation. Similar computing systems may be included in the Clients, Hosts, and routers described herein.

Computing system 900 is representative of any computing system or systems with which the various operational architectures, processes, scenarios, and sequences disclosed herein for providing a communication service and selecting media paths may be implemented.

Computing system 900 is an example of Clients 101-103, although other examples may exist. Computing system 900 comprises communication interface 901, user interface 902, and processing system 903. Processing system 903 is linked to communication interface 901 and user interface 902. Processing system 903 includes a microprocessor and/or processing circuitry 905 and memory device 906 that stores operating software 907. Computing system 900 may include other well-known components such as a battery and enclosure that are not shown for clarity. Computing system 900 may comprise a server, a user device, a desktop computer, a laptop computer, a tablet computing device, or some other user communication apparatus.

Communication interface 901 comprises components that communicate over communication links, such as network cards, ports, radio frequency (RF), processing circuitry and software, or some other communication devices. Communication interface 901 may be configured to communicate over metallic, wireless, or optical links. Communication interface 901 may be configured to use Time Division Multiplex (TDM), Internet Protocol (IP), Ethernet, optical networking, wireless protocols, communication signaling, or some other communication format—including combinations thereof. In some implementations, communication interface 901 is configured to communicate with other end user devices, wherein the communication interface is used to transfer and receive voice communications for the devices. Further, communication interface 901 may interface with a webservice, wherein the service may comprise a media streaming service, gaming service, a food ordering service, online banking service, or some other similar service that can be accessed via a website.

User interface 902 comprises components that interact with a user to receive user inputs and to present media and/or information. User interface 902 may include a speaker, microphone, buttons, lights, display screen, touch screen, touch pad, scroll wheel, communication port, or some other user input/output apparatus—including combinations thereof. User interface 902 may be omitted in some examples.

Processing circuitry 905 comprises a microprocessor and other circuitry that retrieves and executes operating software 907 from memory device 906. Memory device 906 may include volatile and nonvolatile, removable and non-removable media implemented in any method or technology for storage of information, such as computer readable instructions, data structures, program modules, or other data. Memory device 906 may be implemented as a single storage device, but may also be implemented across multiple storage devices or sub-systems. Memory device 906 may comprise additional elements, such as a controller to read operating software 907. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 905 is typically mounted on a circuit board that may also hold memory device 906 and portions of communication interface 901 and user interface 902. Operating software 907 comprises computer programs, firmware, or some other form of machine-readable program instructions. Operating software 907 includes media path selection module 908, although any number of software modules within the application may provide the same operation. Operating software 907 may further include an operating system, utilities, drivers, network interfaces, applications, or some other type of software. When executed by processing circuitry 905, operating software 907 directs processing system 903 to operate computing system 900 as described herein.

In at least one implementation, IP mode determination module 908, when read and executed by processing system 903, directs processing system 903 to determine an IP mode for the network and/or device. For example, a web browser application may be running on a single-mode client device. Additionally, the network may be single-mode. In some embodiments, IP mode determination module 908 determines whether the network is single or dual-mode. In other embodiments, IP mode determination module 908 determines whether the a device is single or dual-mode. Ordering module 910, when read and executed by processing system 903, directs processing system 903 to order the IP addresses, wherein the IP addresses are attempted in order. In some embodiments, the IP addresses are ordered based on network IP mode.

It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of operating a communication node, the method comprising:
determining a network IP mode for a host hosting an application making a service request;
transferring a request for one or more IP addresses associated with the service request;
determining an order for each IP address based on configuration order rules;
probing at least some of the one or more IP addresses in the ordered list of IP addresses to determine reachability; and
generating a list of reachable IP addresses.

2. The method of claim 1, wherein the network IP mode comprises an IPv6 mode.

3. The method of claim 2, further comprising:
converting an IPv4 address to an IPv6 mapped address; and
using an IPv6 socket to access the IPv6 mapped address.

4. The method of claim 1, wherein the configuration order rules comprise giving Fully Qualified Domain Name (FQDN) addresses the highest preference.

5. The method of claim 1, wherein the configuration order rules comprise a network IP mode preference.

6. The method of claim 1, wherein the configuration order rules comprises ignoring IPv4 addresses.

7. The method of claim 1, wherein the one or more IP addresses comprises IPv4 addresses and IPv6 addresses.

8. The method of claim 1, further comprising:
determining the network IP mode is changed to a dual-mode; and
re-ordering each IP address based on configuration order rules.

9. A client device requesting a service provided by an application server, the client device comprising:
a processor configured to determine a network IP mode for a host hosting an application making a service request;
a communication interface configured to transfer a request for one or more IP addresses associated with the service request;
the processor configured to determine an order for each IP address based on configuration order rules;
the communication interface configured to probe at least some of the one or more IP addresses in the ordered list of IP addresses to determine reachability; and
the processor configured to generate a list of reachable IP addresses.

10. The client device of claim 9, wherein the network IP mode comprises an IPv6 mode.

11. The client device of claim 9, further comprising:
the processor configured to convert an IPv4 address to an IPv6 mapped address; and
the communication interface configured to use an IPv6 socket to access the IPv6 mapped address.

12. The client device of claim 9, wherein the configuration order rules comprise giving Fully Qualified Domain Name (FQDN) addresses the highest preference.

13. The client device of claim 9, wherein the configuration order rules comprise a network IP mode preference.

14. The client device of claim 9, wherein the configuration order rules comprises ignoring IPv4 addresses.

15. The client device of claim 9, wherein the one or more IP addresses comprises IPv4 addresses and IPv6 addresses.

16. A computer-readable medium comprising processor-executable instructions comprising:
instructions configured to determine a network IP mode for a host hosting an application making a service request for a requested service;
instructions configured to transfer a request for one or more IP addresses associated with the service request;
instructions configured to determine an order for each IP address based on configuration order rules;
instructions configured to probe at least some of the one or more IP addresses in the ordered list of IP addresses to determine reachability; and
instructions configured to generate a list of resolved destination addresses for a server hosting the requested service.

17. The computer-readable medium of claim 16, wherein the network IP mode comprises a IPv6 only mode.

18. The computer-readable medium of claim 16, wherein the configuration order rules comprises ignoring IPv4 addresses.

19. The computer-readable medium of claim 16, wherein the one or more IP addresses comprises IPv4 addresses and IPv6 addresses.

20. The computer readable medium of claim 16, further comprising:
instructions configured to convert an IPv4 address to an IPv6 mapped address; and
instructions configured to use an IPv6 socket to access the IPv6 mapped address.
